(19) United States
(12) Patent Application Publication
(10) Pub. No.: US 2004/0155742 A1
(43) Pub. Date: Aug. 12, 2004

(54) Rotary solenoid apparatus

(75) Inventors: Motonobu Hasegawa, Kariya-shi (JP); Toshiyuki Kawabe, Toyohashi-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/722,402

(22) Filed: Nov. 28, 2003

(30) Foreign Application Priority Data
Nov. 27, 2002 (JP) 2002-344336

(51) Int. Cl. H01F 7/08

(52) U.S. Cl. 335/220

(57) ABSTRACT

A rotary solenoid apparatus includes a rotation shaft, a regulating means for regulating the rotation range of the rotating shaft, a permanent magnet fixed to the rotating shaft in a body, a spring for urging the rotating shaft in the circumferential direction, a yoke having a pair of stator portions being opposite to the permanent magnet with a predetermined clearance, a coil wound on the yoke and an energization control means for controlling the energization of the coil so that the coil is selectively excited. The permanent magnet is magnetized in the radial direction of the rotation shaft.

### CROSS REFERENCE TO RELATED APPLICATIONS

This application is based on and claims priority to Japanese Patent Application No. 2002-344336 filed on Nov. 27, 2002, the entire content of which is incorporated herein by reference.

### FIELD OF THE INVENTION

The present invention relates to a rotary solenoid apparatus which is used for driving a valve.

### BACKGROUND OF THE INVENTION

A conventional rotary solenoid apparatus includes a rotating shaft, a cam fixed to the rotating shaft. In a body and a stop member contacted to the cam for regulating the rotation angle of the rotating shaft. In this apparatus, since the rotational speed of the rotating shaft is high, crash noise is generated when the cam contacts with the stop member and the abrasion of the stop member and bush is generated by the shock at the contact.

A further conventional rotary solenoid apparatus which overcomes the above problems is disclosed, for example, in Japanese Patent Laid-Open Publication No. 8-55718. This apparatus includes a rotating shaft, a permanent magnet fixed to the rotating shaft in a body, a spring for urging the rotating shaft in the circumferential direction, a yoke on which a pair of stator portions being opposite to the permanent magnet with a predetermined clearance is formed and on which a coil is wound, an energization control means for controlling the energization of the coil so that the coil is selectively excited, a stop member for regulating the rotation angle of the rotating shaft and a damping mechanism for absorbing kinetic energy of the rotating shaft. In this apparatus, a cam which is fixed to the rotating shaft in a body is contacted to the stop member through a rubber and nylon resin.

In the above prior apparatus, since the damping mechanism is provided for absorbing the kinetic energy of the rotating shaft, a large space is required for equipping the apparatus. Further, the number of parts increases and the manufacturing cost of the apparatus is increased.

### SUMMARY OF THE INVENTION

It is, therefore, an object of the present invention to overcome the above drawbacks.

In order to achieve the foregoing object, the present invention provides a rotary solenoid apparatus which includes a rotation shaft, a regulating means for regulating the rotation range of the rotating shaft, a permanent magnet fixed to the rotating shaft in a body, a spring for urging the rotating shaft in the circumferential direction, a yoke having a pair of stator portions being opposite to the permanent magnet with a predetermined clearance, a coil wound on the yoke and an energization control means for controlling the energization of the coil so that the coil is selectively excited, wherein the permanent magnet is magnetized in the radial direction of the rotation shaft.

### BRIEF DESCRIPTION OF THE DRAWINGS

The above and other objects, features and advantages of the present invention will be more apparent and more readily appreciated from the following detailed description of a preferred exemplary embodiment of the present invention, taken in connection with the accompanying drawings, in which;

FIG. 1 is a partly sectional view of an intake manifold on which an embodiment of a rotary solenoid apparatus in accordance with the present invention is mounted;

FIG. 2 is a cross-sectional view taken on line II-II of FIG. 1;

FIG. 3 is a schematic diagram of showing the embodiment of a rotary solenoid apparatus in accordance with the present invention which is in the non-energization condition;

FIG. 4 is a schematic diagram of showing a rotary solenoid apparatus in accordance with the present invention which is in the energization condition;

FIG. 5 is a plan view of a regulating means of the embodiment of the rotary solenoid apparatus;

FIG. 6 is a graph showing a current characteristic when the rotary solenoid apparatus is excited;

FIG. 7 is a graph showing a current characteristic when the enegization of the rotary solenoid is interrupted;

FIG. 8 is a graph showing a characteristic between the angle and the torque in the rotation range of the rotary solenoid apparatus;

FIG. 9 is a cross-sectional view taken on line IX-IX of FIG. 1; and

FIG. 10 is a graph showing a characteristic between the current and the torque in the rotation range of the rotary solenoid apparatus.

### DETAILED DESCRIPTION OF THE PRESENT INVENTION

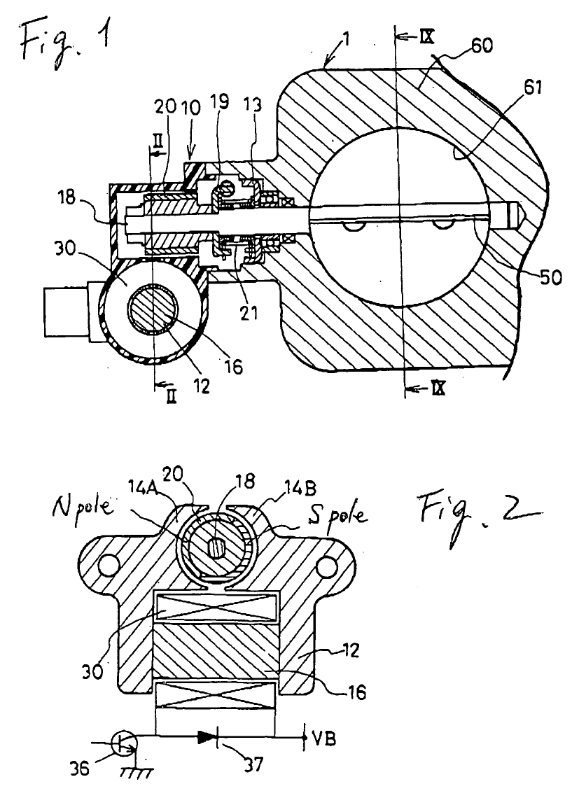

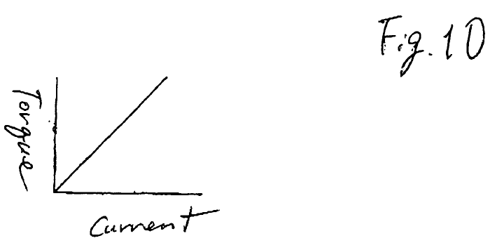

Referring to FIG. 1, FIG. 2 and FIG. 9, an intake manifold 1 of an engine includes a housing 60 in which a intake passage 61 is formed, a valve member 50 disposed in the intake passage 61 for opening and closing the passage 61 and a rotary solenoid apparatus 10 having a rotation shaft 18 on which the valve member 50 is fixed in a body and which is rotated. When the rotary solenoid apparatus 10 is turned on electricity, the rotation shaft 18 is rotated so that the valve member 50 closes the intake passage 61 (clockwise in FIG. 9). When the energization of the solenoid apparatus 10 is interrupted, the rotation shaft 18 is rotated so that the valve member 50 opens the intake passage 61 (counterclockwise in FIG. 9).

As shown in FIG. 2, the rotary solenoid apparatus 10 includes a yoke 12 which is made of a magnetic material and which has approximately U shape. The yoke 12 includes a pair of stator portions 14A, 14B which are opposite with a predetermined clearance. A permanent magnet 20 is disposed between the stator portions 14A and 14B. The permanent magnet 20 is fixed to the rotation shaft 18 in a body so as to be coaxially with the rotation shaft 18. The cross section of the permanent magnet 20 is a perfect circle. The inner circumference of the stator portions 14A and 14B which are opposite to the north pole and the south pole of the permanent magnet 20 has arc shape. The permanent magnet 20 is magnetized in the radial direction with a constant strength.

A coil 30 is wound on a core portion 16 of the yoke 12 through a bobbin (not shown). An electric source VB is connected to one end of the coil 30 and a collector of a transistor 36 constituting an energization control means is connected to the other end of the coil 30. An emitter of the transistor 36 is connected to ground. A driving signal from a control means (not shown) is fed to a base of the transistor 36. When the driving signal is fed to the base of the transistor 36, the collector is conducted to the emitter and the current is supplied from the electric source VB to the coil 30 so as to fully close the valve member 50, and the coil 30 is excited. When the coil 30 is excited, the north pole is formed on the stator portion 14A and the south pole is formed on the stator portion 14B. Thereby, the permanent magnet 20 is rotated so that the valve member 50 fully closes the intake passage 61. A diode 37 is disposed between both ends of the coil 30 and is shorted. The diode 37 allow the current to flow so that the valve member 50 is fully closed when the driving signal is interrupted.

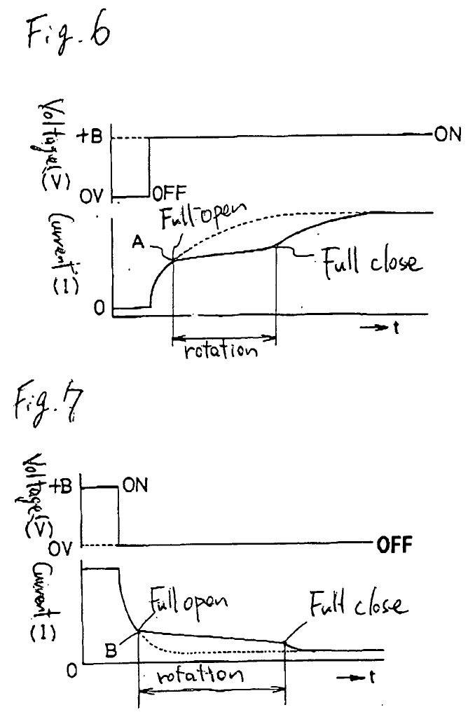

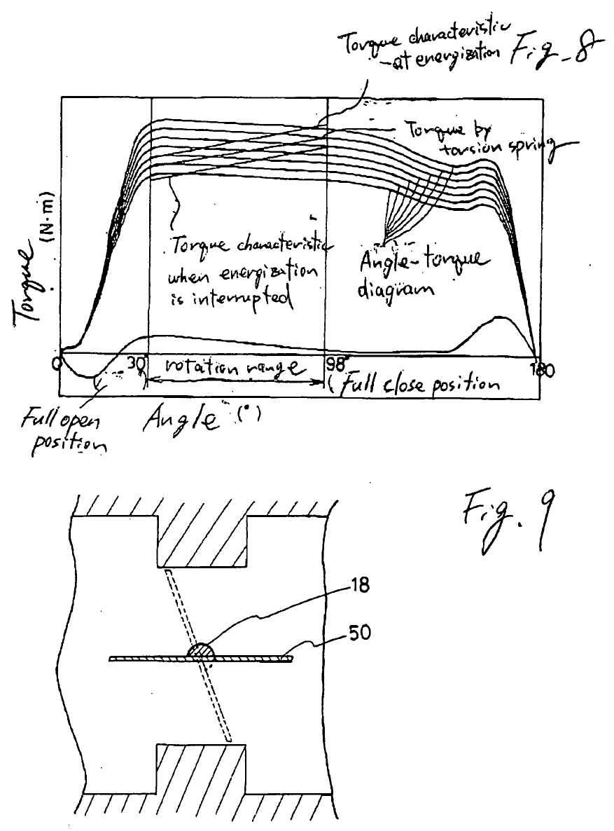

As shown in FIG. 1 and FIG. 5, the rotation shaft 18 is urged by a torsion spring 21 disposed between an arm 19 and a plate 13 and is rotated toward the full open direction (counterclockwise in FIG. 5). The arm 19 is contacted to a full open stopper 71 and then the rotation shaft 18 is held in the full open position. The arm 19 rotates with the rotation shaft 18 in a body. The plate 13 is fixed to the housing 60. The full open stopper 71 comprises a bolt which is screwed to the housing 60. As shown in FIG. 8, the rotational torque of the torsion spring 21 is minimum at the full open position and increases at a constant rate in proportion to approach to the full close position. In this time, as shown in FIG. 3, the rotation shaft 18 fixed to the permanent magnet 20 in a body is in a condition which the rotation shaft 18 is rotated by 30° from a neutral position. In the neutral position, the magnetic force attracting the stator portion 14A by the north pole of the permanent magnet 20 balances out the magnetic force attracting the stator pole portion 14B by the south pole of the permanent magnet 20.

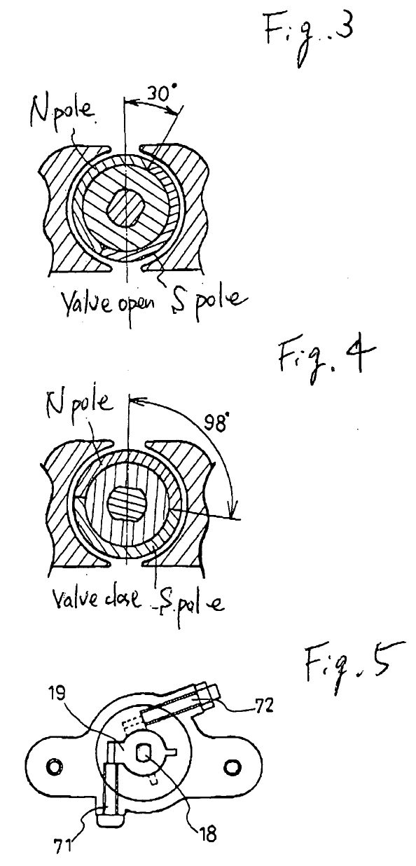

When the coil 30 is tuned on electricity and is excited, the rotation shaft 18 receives the rotational torque by the magnetic field and rotates by 68° as shown in FIG. 4. Then, as shown by a dotted line in FIG. 5, the arm 19 contacts with the full close stopper 72 (when the rotation shaft 18 rotates by 98°) and the rotation shaft 18 is held at the full close position.

In this time, since the permanent magnet 20 is magnetizes in the radial direction, when the permanent magnet 20 is rotated, the variation of the magnetic flux by the permanent magnet 20 interlinking the coil 30 becomes constant with respect to the rotation. Thereby, as shown in FIG. 8, when the constant current is supplied, the rotational torque generated in the rotation shaft 18 becomes approximately constant torque within the rotation range of the rotation shaft 18. Further, the increase of the torque with respect to the constant increasing amount of current becomes approximately constant. Therefore, as shown in FIG. 10, the relationship between the current and the rotational torque in the rotation range becomes approximately proportionality relation.

When the coil 30 is tuned on electricity and is excited, as shown in FIG. 6, the current indicated by dotted line flows in coil 30 by selfinduction and the rotational torque is generated. However, when the current flowing the coil 30 increases by the energization and the rotational torque of the rotation shaft 18 exceeds the rotational torque of the torsion spring 21, the permanent magnet 20 begins to rotate at A point in FIG. 6 and the magnetic flux by the permanent magnet 20 interlinking to the coil 30 changes constantly. Then, a constant electromotive force generates so as to reduce the current value in the coil 30. Thereby, as shown by solid line in FIG. 6, the increase of the current value in coil 30 becomes slowly and the variation becomes constant. As shown in FIG. 8, since the relationship between the current and the rotational torque in the rotation range becomes approximately proportionality relation, the increasing amount of the generated torque becomes also constant. The increasing amount of the generated torque is approximately equal to the urging force (rotational torque) of the torsion spring 21 and the rotation shaft 18 rotates while balancing out the urging force of the torsion spring 21 (while the rotational torque of the rotation shaft 18 valances out the rotational torque of the torsion spring 21), and therefore the rotational speed of the rotation shaft 18 decreases.

On the other hand, when the energization of the coil 30 is interrupted and the coil 30 is not excited, the rotation shaft 18 rotates toward the full open position (counterclockwise in FIG. 5) by the torsion spring 21 and the arm 19 contacts with the full open stopper 71, and then the rotation shaft 18 is held at the full open position.

When the energization of the coil 30 is interrupted and the coil 30 is not excited, as shown in FIG. 7, the current indicated by dotted line flows in coil 30 by self-induction. However, when the current flowing the coil 30 decreases by the interruption of the energization and the rotational torque of the rotation shaft 18 is less than the rotational torque of the torsion spring 21 at B point in FIG. 7, the permanent magnet 20 rotates toward the full open position (counterclockwise in FIG. 5) and the magnetic flux by the permanent magnet 20 interlinking to the coil 30 changes, and a constant electromotive force generates so as to increase the current value in the coil 30. In this time, the current flows in the forward direction by the short of the diode 37 and as shown by solid line in FIG. 7, the decrease of the current value in coil 30 becomes slowly and the variation becomes constant, and the decreasing amount of the generated torque becomes also constant. The decreasing amount of the generated torque is approximately equal to the urging force (rotational torque) of the torsion spring 21 and the rotation shaft 18 rotates while balancing out the urging force of the torsion spring 21 (while the rotational torque of the rotation shaft 18 valances out the rotational torque of the torsion spring 21), and therefore the rotational speed of the rotation shaft 18 decreases. The rotary solenoid apparatus in accordance with the embodiment can be applied to a valve member which is mounted in the intake passage for controlling the effective intake passage length or the intake swirl of an internal combustion engine.

What is claimed is:

1. A rotary solenoid apparatus comprising:
a rotation shaft,
a regulating means for regulating the rotation range of the rotating shaft,
a permanent magnet fixed to the rotating shaft in a body,
a spring for urging the rotating shaft in the circumferential direction,
a yoke having a pair of stator portions being opposite to the permanent magnet with a predetermined clearance,
a coil wound on the yoke and an energization control means for controlling the energization of the coil so that the coil is selectively excited,
wherein the permanent magnet is magnetized in the radial direction of the rotation shaft.

2. A rotary solenoid apparatus as recited in claim 1, wherein energization control means includes a switching element for controlling the energization of the coil and a means for shorting between both ends of the coil so that current flows the same direction as the energization direction of the coil when the energization of the coil is interrupted.
